(19) United States
(12) Patent Application Publication
(10) Pub. No.: US 2014/0059388 A1
(43) Pub. Date: Feb. 27, 2014

(54) DIAGNOSTIC AND PERFORMANCE DATA COLLECTION

(71) Applicants: Anton Patiev, Sankt-Petersburg (RU); Igor Sokolov, Tver (RU); Sergey Stepanov, Sankt-Petersburg (RU)

(72) Inventors: Anton Patiev, Sankt-Petersburg (RU); Igor Sokolov, Tver (RU); Sergey Stepanov, Sankt-Petersburg (RU)

(73) Assignee: RAWLLIN INTERNATIONAL INC., Tortola (VG)

(21) Appl. No.: 13/592,567

(22) Filed: Aug. 23, 2012

(51) Int. Cl. G06F 11/07

(52) U.S. Cl. 714/37; 714/E11.029

(57) ABSTRACT

Technologies are generally described for systems and methods effective to provide an automatic diagnostic data collection system to facilitate diagnosis of technical problems associated with computing device and to facilitate the analysis of marketing and performance metrics of the computing devices. When a user of a computing device calls or accesses a help desk and/or call center, data can be automatically collected from the computing device to allow the help desk operator quickly and accurately diagnose the problem. If no error is specified, general diagnosis data including results of a trace route between a server and the computing device can be collected. If an error is specified, error logs associated with the error can also be collected. The data can be filtered based on a diagnosis request and transferred to the relevant technical support system.

### TECHNICAL FIELD

The subject disclosure relates generally to automatic diagnostic and performance data collection.

### BACKGROUND

Diagnosing a problem for a networked computing device generally requires understanding the context in which the problem occurred. The context can include the type of device, how it was being used, and what went wrong. To fix these problems, help desk operators can ask questions to assist in troubleshooting the problem. Asking questions directly can be both inefficient and inaccurate—inefficient due to the length of time consumed to ask the questions, and inaccurate since the set of users who call for technical support are not likely to be technologically inclined.

The types of questions that are asked can also either assist or hinder the troubleshooting problem. The user of the computing device who calls for technical support may not fully appreciate the relevance of certain contextual details and leave them out in the description of the problem, possibly misleading the call center operator as to the nature of the problem. Likewise, the call center operator may not ask the right questions, and the troubleshooting process can take longer than necessary.

The above-described description is merely intended to provide a contextual overview of diagnostic and performance data collection, and is not intended to be exhaustive.

### SUMMARY

Various non-limiting embodiments provide for automatic diagnostic and performance data collection. In an example embodiment, a system comprises a memory storing computer-executable components and a processor communicatively coupled to the memory that executes or facilitates execution of one or more of the computer executable components. The executable components can include a data retrieval component that collects diagnostic data from a client device and saves the diagnostic data to a data store, and a filtering component that prepares a subset of the diagnostic data based on at least one attribute of a request for the diagnostic data. Also included is a transfer component that transfers a subset of the diagnostic data based on the diagnostic request.

In another example embodiment, a method comprises collecting, by a system including at least one processor, context data from a client device in response to receiving a diagnosis request and saving the context data in a data store. The method also includes filtering the context data into a subset of context data based on the diagnostic request. The method also includes transferring the subset of context data based on the diagnostic request.

In another example embodiment, a computer readable storage device has computer executable instructions that, in response to execution, cause a computing system to perform operations comprising performing a diagnostic test on a client device in response to receiving a diagnosis request from the client device, wherein the performing the diagnostic test includes tracing a route between a server and the client device. The operations also comprise collecting a first set of data including diagnostic data in response to performing the diagnostic test, and selecting a second set of data to collect from the client device based on a client device error identified in the diagnostic request.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a block diagram illustrating an example, non-limiting embodiment of a system for collecting diagnostic and performance data;

FIG. 2 is a block diagram illustrating an example, non-limiting embodiment of a system for collecting and filtering diagnostic data;

FIG. 3 is a block diagram illustrating an example, non-limiting embodiment of a table with a variety of types of diagnostic data;

FIG. 4 is a block diagram illustrating an example, non-limiting embodiment of a system for collecting and transferring data for market analysis;

FIG. 5 is a block diagram illustrating an example, non-limiting embodiment of a system collecting and transferring data for performance analysis;

FIG. 6 illustrates a flow diagram of an example, non-limiting embodiment of a method for collecting and filtering context data;

FIG. 7 illustrates a flow diagram of an example, non-limiting embodiment of a method for performing a diagnostic test and collecting different types of data based on the diagnosis request;

FIG. 8 illustrates a flow diagram of an example, non-limiting embodiment of a method for collecting and filtering data;

FIG. 9 illustrates a block diagram of an example electronic computing environment that can be implemented in conjunction with one or more aspects; and

FIG. 10 illustrates a block diagram of an example data communication network that can be operable in conjunction with various aspects described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the disclosure, as generally described herein, and illustrated in the Figures, can be arranged, substituted, combined, separated, and designed in a wide variety of different configurations, all of which are explicitly contemplated herein.

In various non-limiting embodiments, an automatic diagnostic data collection system is provided to facilitate diagnosis of technical problems associated with computing devices, and to facilitate the analysis of marketing, media playback and performance metrics of the computing devices. When a user of a computing device calls or accesses a help desk and/or call center, data can be automatically collected from the computing device to allow the help desk operator quickly and accurately diagnose the problem.

In an embodiment, general data about the computing device and its user can be collected when a request for technical support is made. Other data can be collected based on the type of diagnosis request. For instance, if technical support is being sought because of a hardware issue, the diagnostic data collected can be related to the hardware issue. In other embodiments, the diagnostic data that is collected from the computing device can include stored error logs. The error logs can indicate where the error occurred (string ID or code) and to which applications. The error logs can also include all errors that occurred on the device including those related to data exchange errors between the device and servers and errors relating to the operating system and user interface.

In some embodiments, the diagnostic data can include information that can be used to analyze marketing and performance metrics. The data collected can then be forwarded to analysis components that perform the analyses.

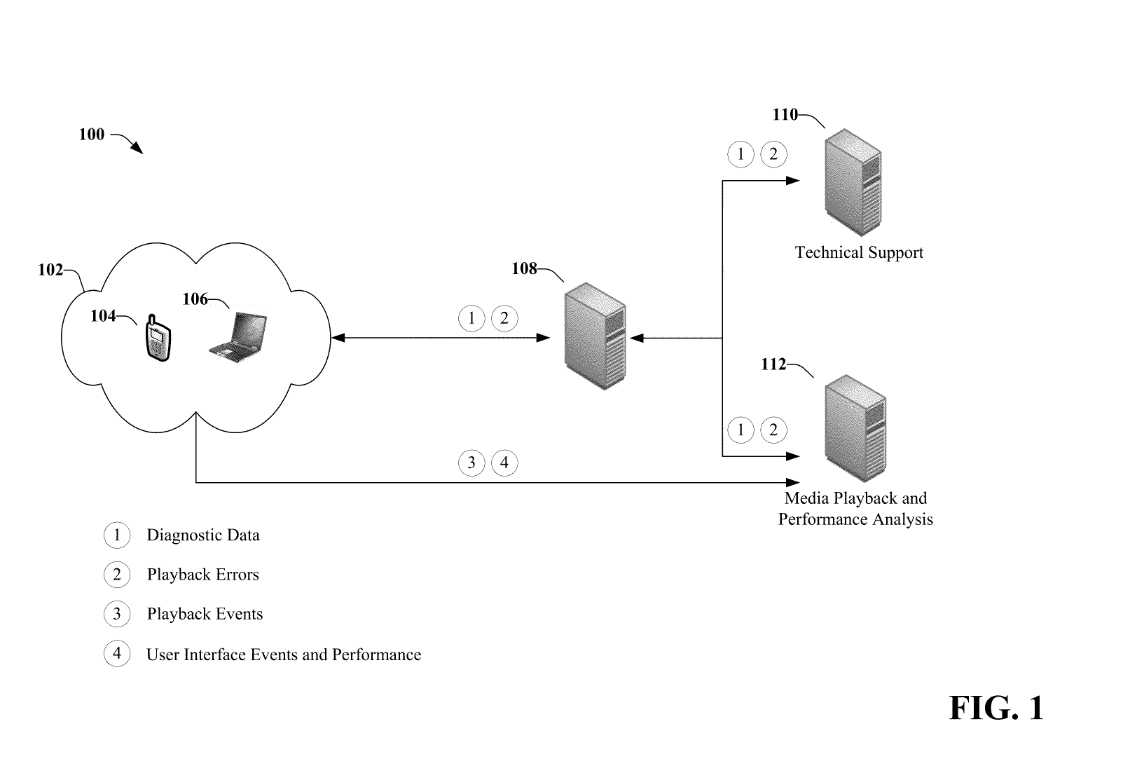

Referring now to FIG. 1, a block diagram illustrating an example, non-limiting embodiment of a system 100 for collecting diagnostic and performance data is shown. System 100 can include a server 108 that interfaces between a network 102 that includes computing devices 104 and 106 and a technical support system 110, and a marketing and performance analysis component 112.

Computing devices 104 and 106 can include cellular phones, personal digital assistants (“PDAs”), tablet computers, and other mobile devices, as well as laptops, computers, and other networked electronic devices. Network 102 can be a mobile network, local area network (“LAN”), wide area network (“WAN”). The computing devices 104 and 106 can be connected to the network 102 wirelessly or via a wired connection. It is to be appreciated that while FIG. 1 shows two computing devices in a network, server 108 can interface with more than one network, and each network can have any number of computing devices within it.

In some embodiments, computing devices 104 and 106 can initiate a connection with the technical support system 110 (which can be a help desk and/or call center). The technical support system 110 can determine an identity of the computing device, and send a diagnosis request to the server 108 to initiate diagnosis data collection from the computing device 104 and/or 106. The diagnosis request can include information identifying the computing device for the server 108.

In other embodiments, the diagnosis request can be initiated by the computing device 104 and/or 106, and can be directed at the server 108 which performs the diagnostic tests and transfers the results, and the data collected to the technical support system 110 for analysis. The diagnosis request, when initiated by the computing device, can include an identifier identifying the computing device that initiated the request.

The diagnostic tests performed by the server 108 can include a trace route between the computing device and server 108 to map network hops between the server 108 and the computing device, as well as to see if there are any network connectivity errors. The server 108 can also gather the results of tests performed by the client device such as speed tests and packet loss tests. In some embodiments, the speed tests and packet loss tests can be performed automatically by the computing device upon applying for diagnosing.

The diagnostic data collected can also include general information about the computing device such as a unique device identifier, the model and type of device, the manufacturer of the device, customer information (including information such as the owner and/or operator of the device), internet protocol (“IP”) address of the device, and other context information such as the memory state and processor state of the device.

The diagnostic information collected by the server 108 can also include playback errors and other error information. This allows an operator, virtual or otherwise, of the help desk and/or call center to see both errors in real time as well as an error history of the computing device. The playback error information can include error history logs that contain error codes, where the error occurred (code and/or string), as well as information about all errors that occurred on the device including those related to data exchange errors between the device and servers and errors relating to the operating system and user interface. The playback error data can be collected in response to the diagnosis request from the computing device indicating an error in playback.

Data relating to playback events and user interface events and performance can be collected directly by the marketing and performance analysis systems 112. The data associated with playback events can include the date and time of the event, information about the device (type, model, manufacturer, software version, etc) as well as customer information and information relating to a viewing session (user ID, video ID, quality, MIME-type, and consumption mode), and event codes identifying playback events (start, stop, pause, buffering, fast forward, rewind, and etc.). Performance and user interface data can include information such as performance metrics (time to boot up, frames per second, and etc.) as well as user interface information (number and types of display screens, resolution, and etc.).

In some embodiments, the information relating to media playback events and user interface events and performance can be sent directly from the computing devices 104 and 106 to marketing and performance analysis system 112. The information can be sent in real time, or at predefined periodic intervals. In other embodiments, the information can be sent in response to computing device 104 and/or 106 requesting diagnosis with technical support system 110.

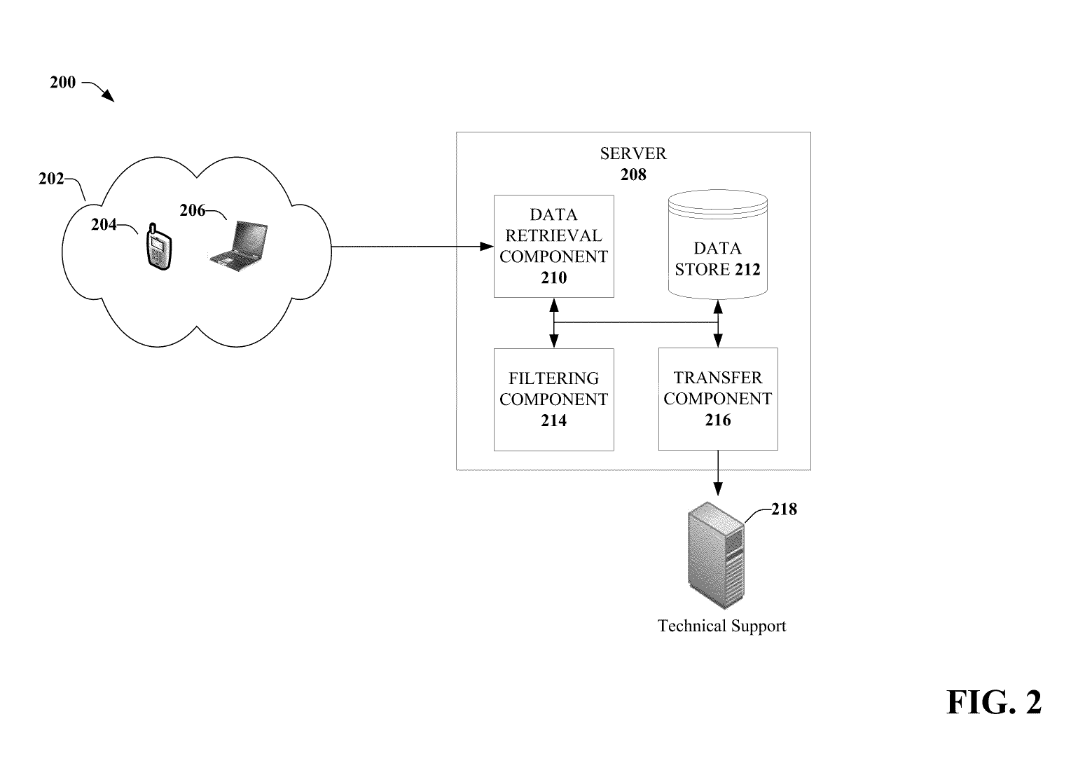

Turning now to FIG. 2, a block diagram illustrating an example, non-limiting embodiment of a system for collecting and filtering diagnostic data is shown. System 200 includes a network 202 with computing devices 204 and 206. Server 208 facilitates communications between network 202 and a technical support system 218. Server 208 includes a data retrieval component 210, a data store 212, a filtering component 214, and a transfer component 216.

Data retrieval component 210 can be configured to collect diagnostic data from computing devices 204 and/or 206. The data retrieval component 210 can collect diagnostic data from the computing devices in response to the server 208 receiving a diagnosis request from one of the computing devices. Alternatively, in other embodiments, the data retrieval component 210 can collect the diagnosis request in response to technical support system 218 receiving a diagnosis request from one or more of the computing devices. In still other embodiments, the data retrieval component 210 can collect data from computing devices 204 and/or 206 at predefined intervals.

In an embodiment, the diagnosis request can include identifying information that identifies the device from which to collect data. The identifying information can include a user or device ID. The identifying information can also include an address of the computing device on the network 202, such as an IP address, a media access control (“MAC”) address, and/or other suitable addresses.

The data retrieval component 210 can also collect a trace route log from between the server 208 and the computing devices 204 and/or 206. The trace route can be performed by either the server 208 or by the computing devices. In some embodiments the server 208 initiates the trace route when the server 208 receives the diagnostic request. In other embodiments, the technical support system 218 initiates the trace route when one of the computing devices applies for diagnosis.

The data retrieval component 210 can be configured to save the diagnostic data in the data store 212. The data store 212 can store past records of trace routes and other diagnostic data. The data can be stored indefinitely or can be purged manually or at predefined intervals. It is to be appreciated that while FIG. 2 shows that data store 212 is associated with server 208, in other embodiments, data store 212 can be associated with technical support system 218 or otherwise separate from server 208.

Filtering component 214 can be configured to prepare a subset of the diagnostic data based on at least one attribute of the request for the diagnostic data. In some embodiments, the attribute can be based on the source of the request, such as whether the diagnosis request originates with the technical support system 218, or one or more of computing devices 204 and 206.

In other embodiments, the filtering component 214 can filter the diagnostic data based on an identified problem in the diagnostic request. The filtering component 214 can prepare a subset of the diagnostic data that is relevant to the reason for the diagnostic request. For instance, if the computing device is experience network connectivity issues, diagnostic data relating to hardware or operating system functionality may be more relevant than application specific information. If there is an error during playback of a video, diagnostic data relating to video drivers and software applications can be more relevant and thus included.

In some embodiments, the diagnosis request can be associated with a request to analyze playback events and user interface events and performance. Filtering component 214 can prepare a subset of diagnostic data based on the request. The subset of data associated with playback events can include the date and time of the event, information about the device (type, model, manufacturer, software version, etc) as well as customer information and information relating to a viewing session (user ID, video ID, quality, MIME type, and consumption mode), and event codes identifying playback events (start, stop, pause, buffering, fast-forward, rewind, and etc.). Performance and user interface data can include information such as performance metrics (time to boot up, frames per second, and etc.) as well as user interface information (number and types of display screens, resolution, and etc.).

If the diagnosis request is associated with an identified error, the subset of diagnostic data prepared can include a time of error, an internet protocol address of the computing device, an error code, and an error history log associated with the computing device. In some cases, the diagnostic request may not specify a particular error. When that happens, filtering component 214 can prepare a subset of general diagnostic data such as the date and time of the request, the user ID, the device ID, type, and model, customer information, device IP address, trace route log speed test result, IP address of the server 208 and the current loading and status of the server 208 (memory, CPU, network interfaces, disk, and etc.).

Once the subset of diagnostic data is prepared, transfer component 216 can be configured to transfer the subset of the diagnostic data based on the diagnostic request. For general diagnostic queries, or when a problem is identified in the diagnostic request, the transfer component 216 can transfer the subset of diagnostic data to a technical support system 218. In other embodiments, when the diagnosis request asks for playback events and user interface events or performance metrics, the transfer component 216 can transfer the subset of diagnostic data to a media playback analysis system or a performance analysis system.

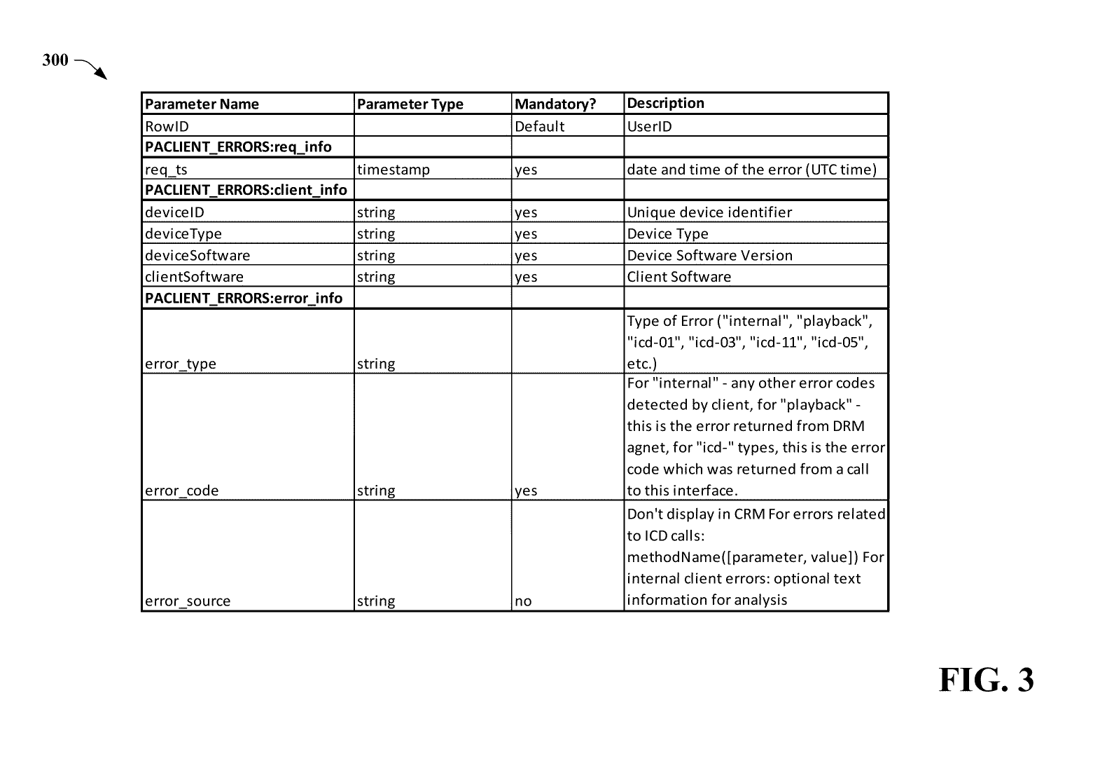

Turning now to FIG. 3, a block diagram illustrating an example, non-limiting embodiment of a table with a variety of types of diagnostic data is shown. Table 300 depicts exemplary categories of data that can be collected (e.g., by data retrieval component 210) in response to a request for diagnosis. Depending on the type of the diagnosis request, tables with different sets of data can be prepared (e.g., by filtering component 214).

FIG. 3 depicts an exemplary set of diagnostic data that can be prepared in response to a diagnostic request for an error associated with the computing device or a software application on the computing device. In this exemplary table 300, the first set of parameters gathered include general information such as the user ID and a timestamp of the error. The second set of parameters under “PACLIENT_ERRORS:client_info” include information such as the unique device identifier, device type, device software version and client software type. The third set of parameters, under “PACLIENT_ERRORS:error_info” include diagnostic data relating to the type of error, the specific error code, and the source of the error. This portion of diagnostic data can be retrieved from one or more error logs stored on the computing device.

It is to be appreciated that diagnostic requests issued for different reasons may have tables with different sets of parameters. Table 300 is merely an exemplary table generated in response to a diagnosis request for an error associated with the computing device and/or software application on the computing device. Errors with network connectivity for instance may have different sets of data including information relating to speed tests, trace routes, and other types of related data.

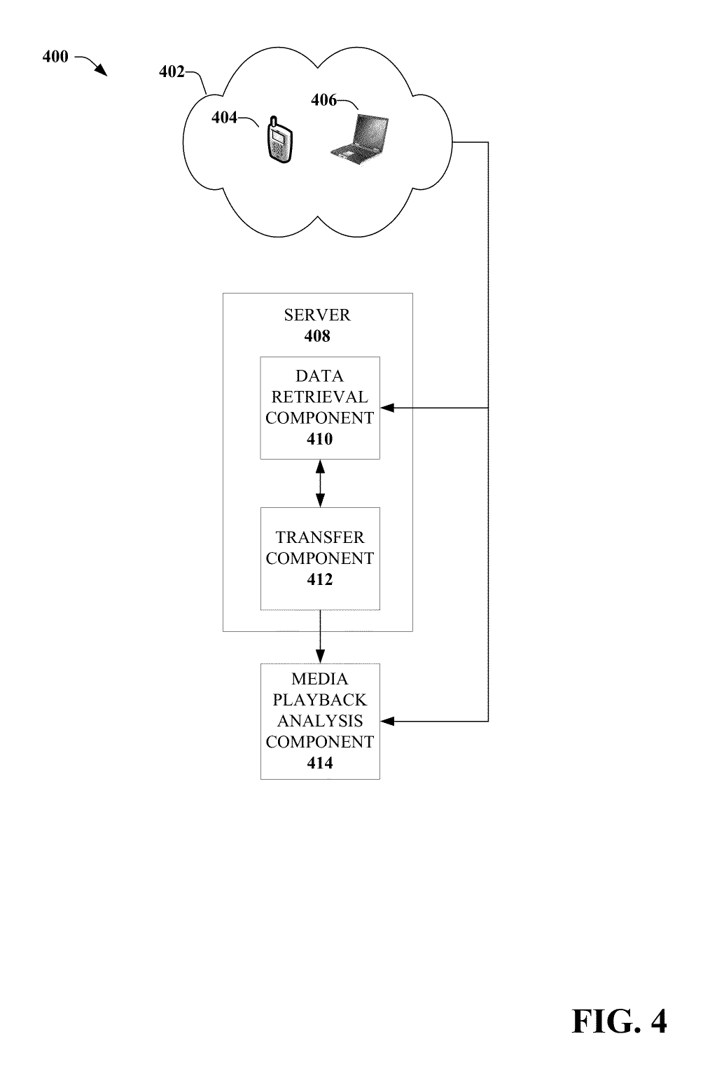

Turning now to FIG. 4, a block diagram illustrating an example, non-limiting embodiment of a system for collecting and transferring data for market analysis is shown. System 400 includes a network 402 with computing devices 404 and 406. Server 408 can facilitates communication between network 402 and a media playback analysis component 414. Server 408 includes a data retrieval component 410 and a transfer component 412.

Data retrieval component 410 can be configured to collect diagnostic data from computing devices 404 and/or 406. The data retrieval component 410 can collect diagnostic data from the computing devices in response to the server 408 receiving a diagnosis request from one of the computing devices or a technical support system. Alternatively, data retrieval component 410 can collect the diagnostic information continuously, or periodically at predetermined intervals.

The diagnostic data collected by data retrieval component 410 can include data associated with media playback events and a user session on the computing device. The media playback event data can include the date and time of the event, information about the device (type, model, manufacturer, software version, etc) as well as customer information and information relating to a viewing session (user ID, video ID, quality, MIME-type, and consumption mode), and event codes identifying playback events (start, stop, pause, buffering, fast forward, rewind, and etc.). Media playback component 414 can analyze this data for marketing and programming purposes.

In some embodiments, transfer component 412 can be configured to send the data relating to media playback events to the media playback component 414 along with the general diagnostic data (information about the device). In other embodiments, media playback component 414 can receive the general diagnostic data from transfer component 412, and receive the media playback event data directly from the computing devices 404 and/or 406.

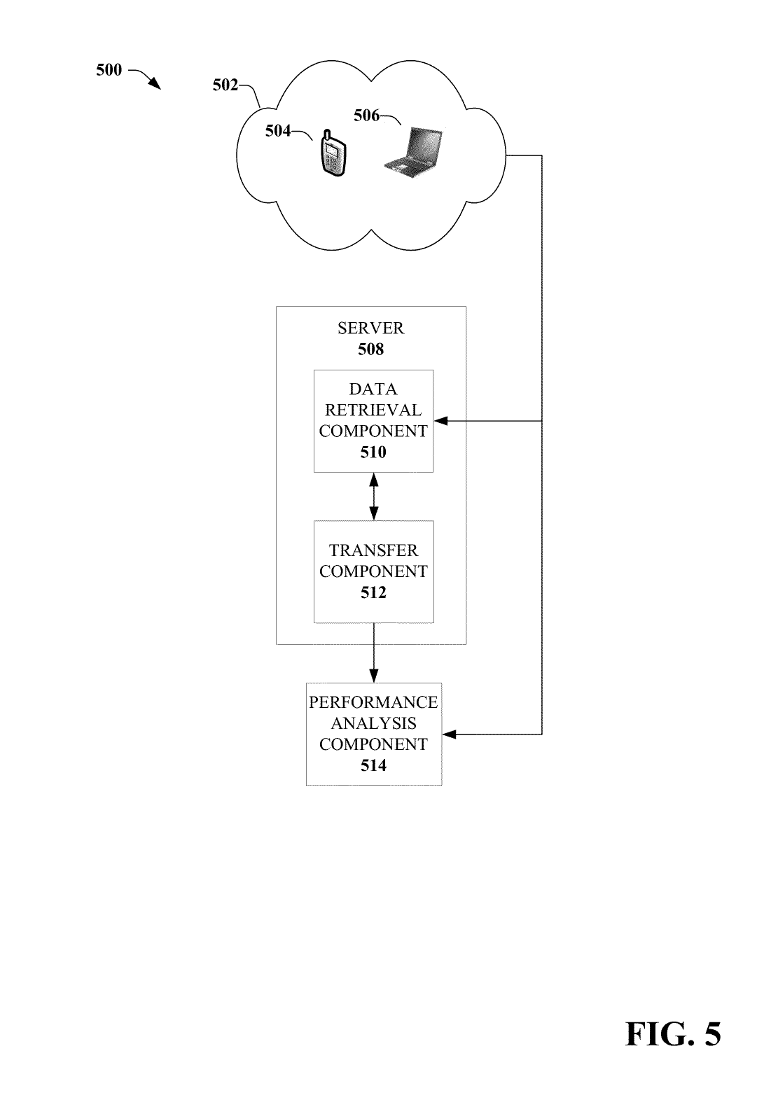

Turning now to FIG. 5, a block diagram illustrating an example, non-limiting embodiment of a system collecting and transferring data for performance analysis is shown. System 500 includes a network 502 with computing devices 504 and 506. Server 508 can facilitates communication between network 502 and a performance analysis component 514. Server 508 includes a data retrieval component 510 and a transfer component 512.

Data retrieval component 510 can be configured to collect diagnostic data from computing devices 504 and/or 506. The data retrieval component 510 can collect diagnostic data from the computing devices in response to the server 508 receiving a diagnosis request from one of the computing devices or a technical support system. Alternatively, data retrieval component 510 can collect the diagnostic information continuously, or periodically at predetermined intervals.

The diagnostic data collected by data retrieval component 510 can include data associated with user interface events and performance metrics on the computing device. The data can include the date and time of the event, information about the device (type, model, manufacturer, software version, etc), user interface data such as number and types of display screens and their resolution as well as performance metrics such as time to boot, frames per second, and etc. Performance analysis component 514 can analyze this data to rate the performance of the computing devices and the network 502.

In some embodiments, transfer component 512 can be configured to send the data relating to media playback events to the performance analysis component 514 along with the general diagnostic data (information about the device). In other embodiments, performance analysis component 514 can receive the general diagnostic data from transfer component 512, and receive the performance metrics and user interface data directly from the computing devices 504 and/or 506.

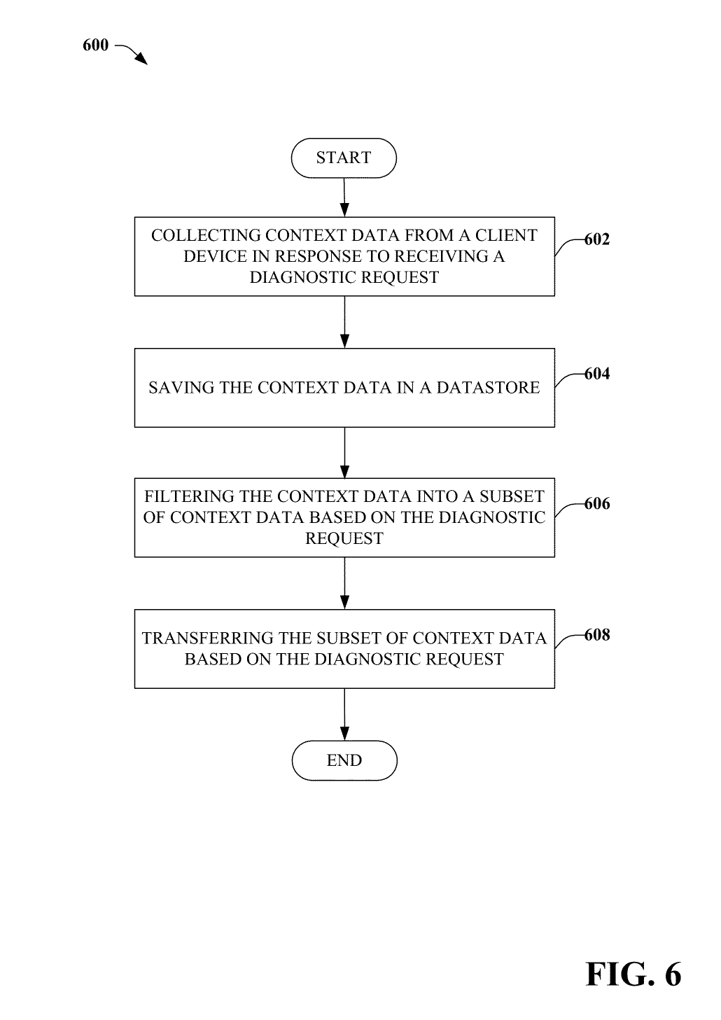

FIGS. 6-8 illustrates processes in connection with the aforementioned systems. The processes in FIGS. 6-8 can be implemented for example by systems 100-500 illustrated in FIGS. 1-5 respectively. Additionally, it should be appreciated that the methods disclosed in this specification are capable of being stored as computer-executable instructions on a non-transitory computer readable medium that in response to execution, cause a system including at least one processor to perform operations in accordance with the methods.

FIG. 6 illustrates a flow diagram of an example, non-limiting embodiment of a method 600 for collecting and filtering context data. At 602, context data is collected (e.g., by data retrieval component 210, 410, and/or 510) from a client device in response to receiving a diagnostic request. The diagnostic request can be received directly from one of the client devices, or can be received from a technical support system (e.g., 218) after the client device provides applies for assistance. In some embodiments, the context data can be collected from the client devices continuously, or periodically at predefined intervals.

In some embodiments, the results of a trace route between a server (e.g., 108, 208, 408, and/or 508) and the client device can be collected, as well as results of a speed test performed by the client device. Other context data that can be collected includes information about an operator of the client device, such as customer name and information, as well as information about the device such as the model, type, version, and manufacturer. The context data can also include an address of the client device on a network, such as an IP address or MAC address. Step 602 can be followed by step 604.

At 604, the context data can be saved in a data store (e.g. 212). The data store can store past records of trace routes and other context data. The data can be stored indefinitely or can be purged manually or at predefined intervals. Step 604 can be followed by step 606.

At 606, the context data is filtered into a subset of context data based on the diagnostic request. A subset of the context data can be based on at least one attribute of the request for the context data. In some embodiments, the attribute can be based on the source of the request, such as whether the diagnosis request originates with the technical support system, or one or more of the client devices. In other embodiments, the context data can be filtered based on an identified problem in the diagnostic request, or whether a problem is identified at all. A subset of the context data can be prepared that is relevant to the reason for the diagnostic request. For instance, if the client device is experience network connectivity issues, context data relating to hardware or operating system functionality may be more relevant than application specific information. If there is an error during playback of a video, context data relating to video drivers and software applications may be more relevant. Step 606 can be followed by step 608.

At 608, the subset of context data is transferred based on the diagnostic request. For general diagnostic queries, or when a problem is identified in the diagnostic request, the subset of diagnostic data to a technical support system. In other embodiments, when the diagnosis request asks for playback events and user interface events or performance metrics, the subset of diagnostic data to a media playback analysis system or a performance analysis system.

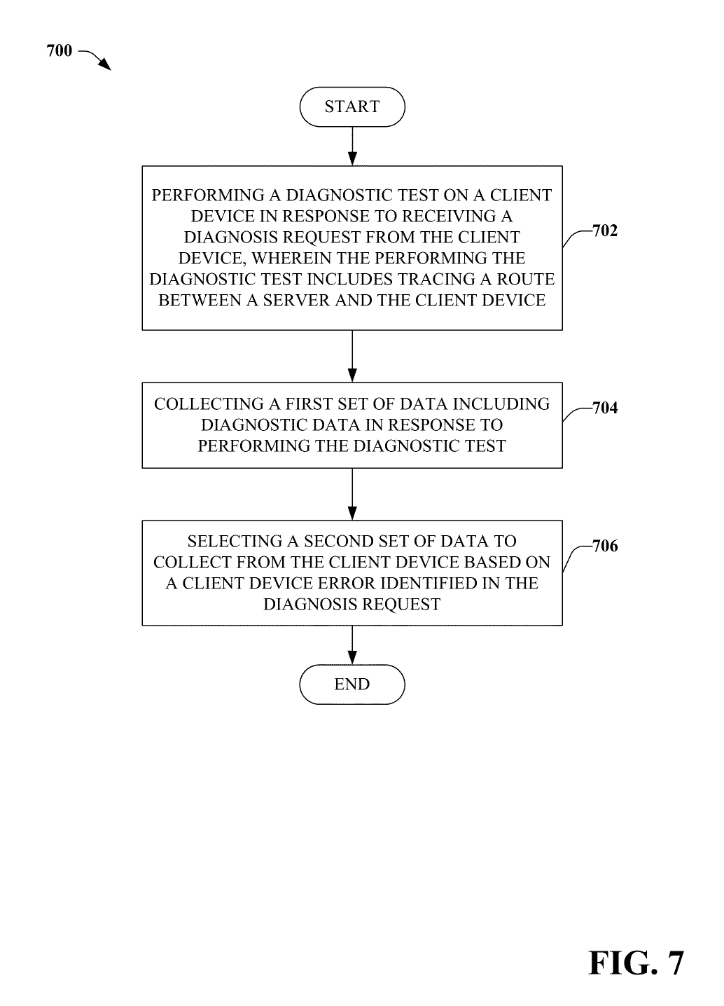

Turning now to FIG. 7, a flow diagram of an example, non-limiting embodiment of a method for performing a diagnostic test and collecting different types of data based on the diagnosis request is shown. At 702, A diagnostic test on a client device is performed in response to receiving a diagnosis request from the client device. The diagnosis test can include performing a trace route test between a server and the client device, measuring the time it takes for a packet to be sent between nodes between the server and the client device. The trace route test can also initiate a speed test performed by the client device, to measure the network connection bandwidth of the client device. Step 702 can be followed by step 704.

At 704, a first set of data, including diagnostic data is collected in response to performing the diagnostic test. The diagnostic data can include the trace route and speed test results as well as the results of other tests performed on the client device. The first set of data can also include general data about the client device such as a unique device identifier, the model and type of device, the manufacturer of the device, customer information (including information such as the owner and/or operator of the device), internet protocol (“IP”) address of the device, and other context information such as the memory state and processor state of the device.

In some embodiments, the first set of data can be collected when the client device applies for help with a technical support system. In other embodiments, the first set of data can be continuously collected and updated whenever the first set of data changes, or the first set of data can be collected at regular intervals of predefined frequency. Step 704 can be followed by step 706.

At 706, a second set of data is collected from the client device based on a client device error identified in the diagnostic request. The second set of data selected can be such that it has some relevance to the error identified in the diagnosis request. For instance, if the computing device is experience network connectivity issues, data relating to hardware or operating system functionality may be more relevant than application specific information. If there is an error during playback of a video, data relating to video drivers and software applications can be more relevant and thus included.

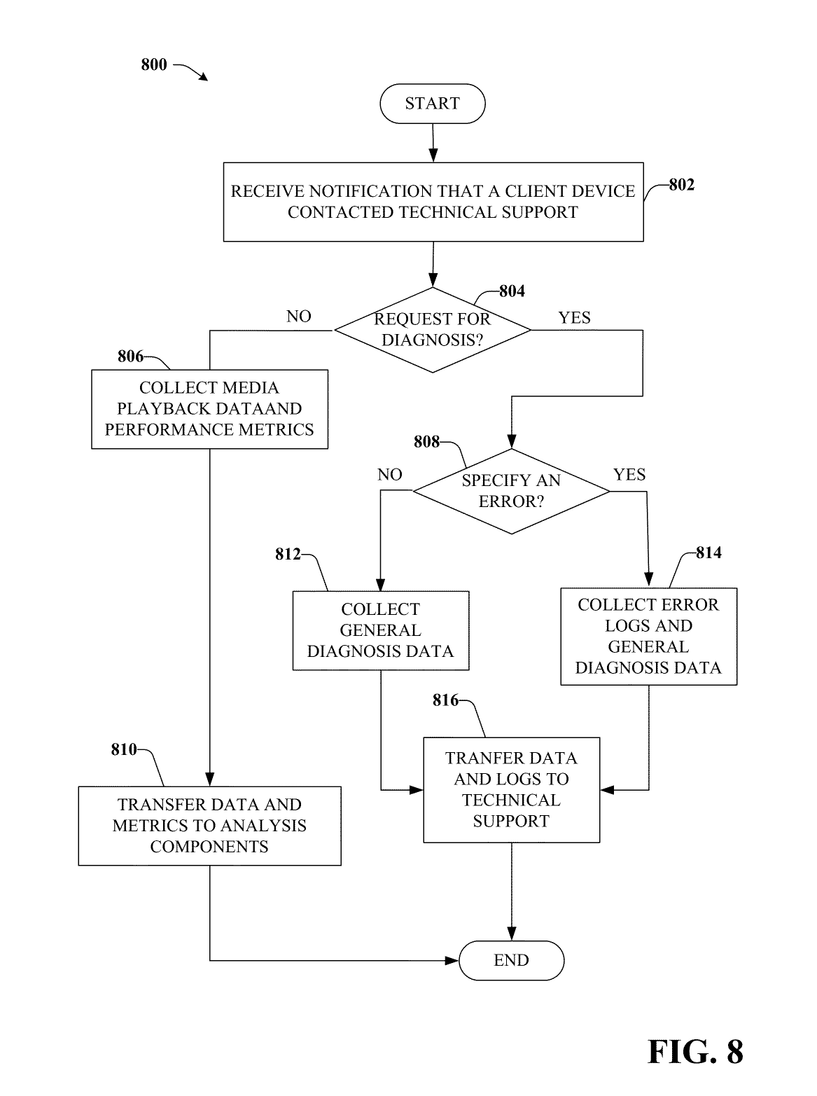

Turning now to FIG. 8, a flow diagram of an example, non-limiting embodiment of a method for collecting and filtering data is shown. At 802, a notification is received that a client device has contacted technical support. When the client device contacts technical support, there may be a particular error with the client device, or there may be general problems. In some embodiments, there may be no problems at all, and the operator of the client device just wants to analyze certain performance or playback events. At 804, it is determined whether there is a request for diagnosis of a problem. If there is no request, at 806, media playback data and performance metrics can be collected.

Media playback data can include the date and time of events, information about the device (type, model, manufacturer, software version, etc) as well as customer information and information relating to a viewing session (user ID, video ID, quality, MIME-type, and consumption mode), and event codes identifying playback events (start, stop, pause, buffering, fast forward, rewind, and etc.). Performance metrics can include time to boot, frames per second, resolution of the display screen, and other similar types of data. At 810, the media playback data and performance metrics are transferred to analysis components for marketing and performance feedback.

On the other hand if there is a request for diagnosis at 804, at 808 a determination can be made about whether the request specifies a particular error. If there is no error specified, general diagnosis data can be collected at 812. General diagnosis data can include a client device identifier, the model and type of device, the manufacturer of the device, customer information (including information such as the owner and/or operator of the device), internet protocol (“IP”) address of the device, and other context information such as the memory state and processor state of the device. Trace route and speed test results can also be collected.

At 814, if an error is specified, error logs associated with the error can be collected. At 814, the general diagnosis data as well as the specific error logs can be collected. At 816, the genera data and error logs (if any), can be transferred to technical support for analysis.

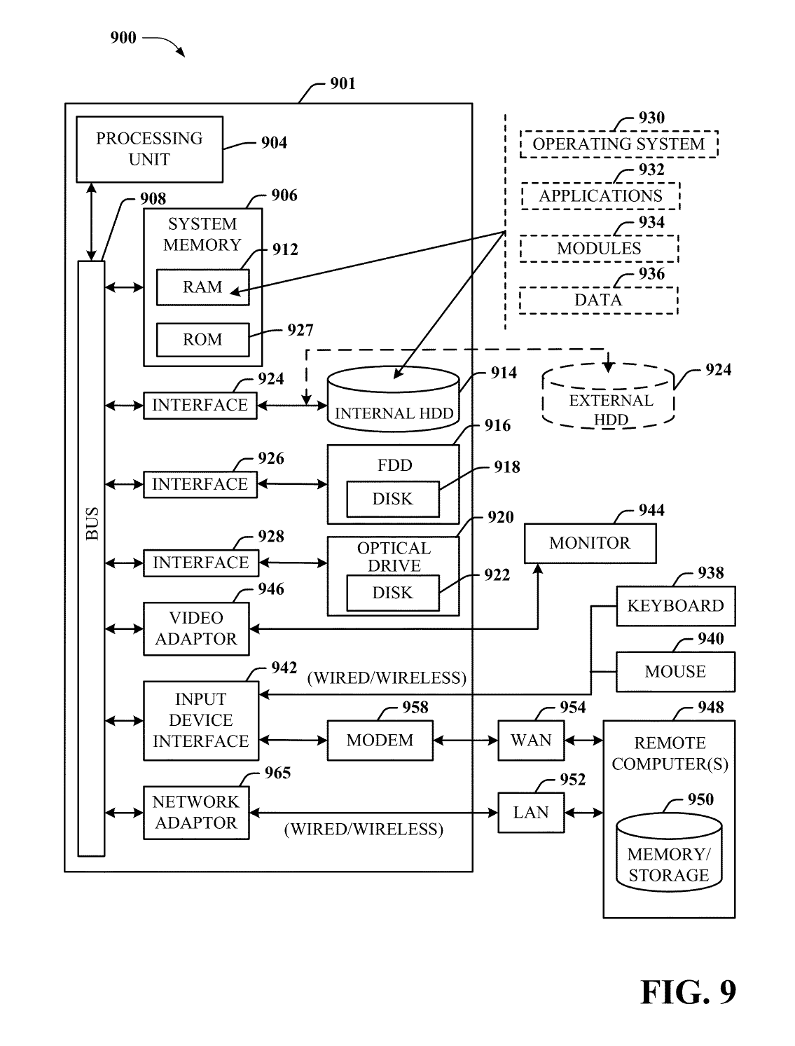

With reference to FIG. 9, an exemplary environment 900 for implementing various aspects described herein includes a computer 902, the computer 902 including a processing unit 904, a system memory 906 and a system bus 908. The system bus 908 connects system components including, but not limited to, the system memory 906 to the processing unit 904. The processing unit 904 can be any of various commercially available processors. Dual microprocessors and other multi processor architectures can also be employed as the processing unit 904.

The system bus 908 can be any of several types of bus structure that can further interconnect to a memory bus (with or without a memory controller), a peripheral bus, and a local bus using any of a variety of commercially available bus architectures. The system memory 906 includes read-only memory (ROM) 910 and random access memory (RAM) 912. A basic input/output system (BIOS) is stored in a non-volatile memory 910 such as ROM, EPROM, EEPROM, which BIOS contains the basic routines that help to transfer information between elements within the computer 902, such as during start-up. The RAM 912 can also include a high-speed RAM such as static RAM for caching data.

The computer 902 further includes an internal hard disk drive (HDD) 914 (e.g., EIDE, SATA), which internal hard disk drive 914 can also be configured for external use in a suitable chassis (not shown), a magnetic floppy disk drive (FDD) 916, (e.g., to read from or write to a removable diskette 918) and an optical disk drive 920, (e.g., reading a CD-ROM disk 922 or, to read from or write to other high capacity optical media such as the DVD). The hard disk drive 914, magnetic disk drive 916 and optical disk drive 911 can be connected to the system bus 908 by a hard disk drive interface 924, a magnetic disk drive interface 926 and an optical drive interface 928, respectively. The interface 924 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 902, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, can also be used in the exemplary operating environment, and further, that any such media can contain computer-executable instructions for performing the methods of the disclosed innovation.

A number of program modules can be stored in the drives and RAM 912, including an operating system 930, one or more application programs 932, other program modules 934 and program data 936. All or portions of the operating system, applications, modules, and/or data can also be cached in the RAM 912. It is to be appreciated that aspects of the subject disclosure can be implemented with various commercially available operating systems or combinations of operating systems.

A user can enter commands and information into the computer 902 through one or more wired/wireless input devices, e.g., a keyboard 938 and a pointing device, such as a mouse 940. Other input devices (not shown) may include a microphone, an IR remote control, a joystick, a game pad, a stylus pen, touch screen, or the like. These and other input devices are often connected to the processing unit 904 through an input device interface 942 that is coupled to the system bus 908, but can be connected by other interfaces, such as a parallel port, an IEEE 1394 serial port, a game port, a USB port, an IR interface, etc.

A monitor 944 or other type of display device is also connected to the system bus 908 through an interface, such as a video adapter 946. In addition to the monitor 944, a computer typically includes other peripheral output devices (not shown), such as speakers, printers, etc.

The computer 902 can operate in a networked environment using logical connections by wired and/or wireless communications to one or more remote computers, such as a remote computer(s) 948. The remote computer(s) 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 950 is illustrated. The logical connections depicted include wired/wireless connectivity to a local area network (LAN) 952 and/or larger networks, e.g., a wide area network (WAN) 954. Such LAN and WAN networking environments are commonplace in offices and companies, and facilitate enterprise-wide computer networks, such as intranets, all of which may connect to a global communications network, e.g., the Internet.

When used in a LAN networking environment, the computer 902 is connected to the local network 952 through a wired and/or wireless communication network interface or adapter 956. The adapter 956 may facilitate wired or wireless communication to the LAN 952, which may also include a wireless access point disposed thereon for communicating with the wireless adapter 956.

When used in a WAN networking environment, the computer 902 can include a modem 958, or can be connected to a communications server on the WAN 954, or has other means for establishing communications over the WAN 954, such as by way of the Internet. The modem 958, which can be internal or external and a wired or wireless device, is connected to the system bus 908 through the serial port interface 942. In a networked environment, program modules depicted relative to the computer 902, or portions thereof, can be stored in the remote memory/storage device 950. It will be appreciated that the network connections shown are exemplary and other means of establishing a communications link between the computers can be used.

The computer 902 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi® and Bluetooth™ wireless technologies. Thus, the communication can be a predefined structure as with a conventional network or simply an ad hoc communication between at least two devices.

Wi-Fi, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11(a, b, g, n, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), or other bands (e.g., 802.11g, 802.11n, . . . ) so the networks can provide real-world performance similar to the basic 10BaseT wired Ethernet networks used in many offices.

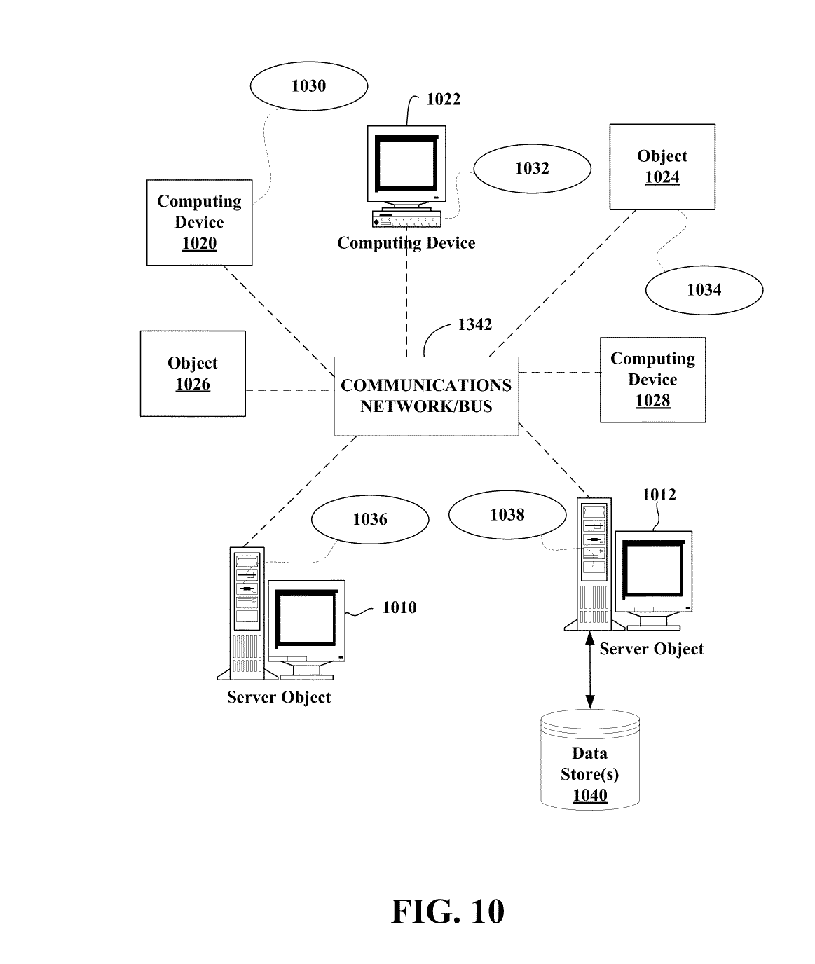

FIG. 10 provides a schematic diagram of an exemplary networked or distributed computing environment. The distributed computing environment comprises computing objects 1010, 1012, etc. and computing objects or devices 1020, 1022, 1024, 1026, 1028, etc., which may include programs, methods, data stores, programmable logic, etc., as represented by applications 1030, 1032, 1034, 1036, 1038 and data store(s) 1040. It can be appreciated that computing objects 1010, 1012, etc. and computing objects or devices 1020, 1022, 1024, 1026, 1028, etc. may comprise different devices, including multimedia display device 100 or similar devices depicted within the illustrations, or other devices such as a mobile phone, personal digital assistant (PDA), audio/video device, MP3 players, personal computer, laptop, etc. It should be further appreciated that data store(s) 1040 can include data store 108, or other similar data stores disclosed herein.

Each computing object 1010, 1012, etc. and computing objects or devices 1020, 1022, 1024, 1026, 1028, etc. can communicate with one or more other computing objects 1010, 1012, etc. and computing objects or devices 1020, 1022, 1024, 1026, 1028, etc. by way of the communications network 1042, either directly or indirectly. Even though illustrated as a single element in FIG. 10, communications network 1042 may comprise other computing objects and computing devices that provide services to the system of FIG. 10, and/or may represent multiple interconnected networks, which are not shown. Each computing object 1010, 1012, etc. or computing object or devices 1020, 1022, 1024, 1026, 1028, etc. can also contain an application, such as applications 1030, 1032, 1034, 1036, 1038, that might make use of an API, or other object, software, firmware and/or hardware, suitable for communication with or implementation of the techniques and disclosure described herein.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the systems automatic diagnostic data collection as described in various embodiments herein.

Thus, a host of network topologies and network infrastructures, such as client/server, peer-to-peer, or hybrid architectures, can be utilized. The “client” is a member of a class or group that uses the services of another class or group to which it is not related. A client can be a process, i.e., roughly a set of instructions or tasks, that requests a service provided by another program or process. The client process utilizes the requested service, in some cases without having to “know” any working details about the other program or the service itself.

In a client/server architecture, particularly a networked system, a client is usually a computer that accesses shared network resources provided by another computer, e.g., a server. In the illustration of FIG. 10, as a non-limiting example, computing objects or devices 1020, 1022, 1024, 1026, 1028, etc. can be thought of as clients and computing objects 1010, 1012, etc. can be thought of as servers where computing objects 1010, 1012, etc., acting as servers provide data services, such as receiving data from client computing objects or devices 1020, 1022, 1024, 1026, 1028, etc., storing of data, processing of data, transmitting data to client computing objects or devices 1020, 1022, 1024, 1026, 1028, etc., although any computer can be considered a client, a server, or both, depending on the circumstances.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques described herein can be provided standalone, or distributed across multiple computing devices or objects.

In a network environment in which the communications network 1042 or bus is the Internet, for example, the computing objects 1010, 1012, etc. can be Web servers with which other computing objects or devices 1020, 1022, 1024, 1026, 1028, etc. communicate via any of a number of known protocols, such as the hypertext transfer protocol (HTTP). Computing objects 1010, 1012, etc. acting as servers may also serve as clients, e.g., computing objects or devices 1020, 1022, 1024, 1026, 1028, etc., as may be characteristic of a distributed computing environment.

Reference throughout this specification to “one embodiment,” “an embodiment,” “a disclosed aspect,” or “an aspect” means that a particular feature, structure, or characteristic described in connection with the embodiment or aspect is included in at least one embodiment or aspect of the present disclosure. Thus, the appearances of the phrase “in one embodiment,” “in one aspect,” or “in an embodiment,” in various places throughout this specification are not necessarily all referring to the same embodiment. Furthermore, the particular features, structures, or characteristics may be combined in any suitable manner in various disclosed embodiments.

As utilized herein, terms “component,” “system,” “module”, “interface,” “user interface”, and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In an aspect, a component can emulate an electronic component via a virtual machine, e.g., within a cloud computing system.

The subject matter described herein can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can include, but are not limited to, a magnetic storage device, e.g., hard disk; floppy disk; magnetic strip(s); an optical disk (e.g., compact disk (CD), a digital video disc (DVD), a Blu-ray Disc™ (BD)); a smart card; a flash memory device (e.g., card, stick, key drive); and/or a virtual device that emulates a storage device and/or any of the above computer-readable media.

The word “exemplary” where used herein means serving as an example, instance, or illustration. For the avoidance of doubt, the subject matter disclosed herein is not limited by such examples. In addition, any aspect or design described herein as “exemplary,” “demonstrative,” or the like, is not necessarily to be construed as preferred or advantageous over other aspects or designs, nor is it meant to preclude equivalent exemplary structures and techniques known to those of ordinary skill in the art.

As used herein, the term “infer” or “inference” refers generally to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference can be employed to identify a specific context or action, or can generate a probability distribution over states of interest based on a consideration of data and events, for example.

Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

Furthermore, to the extent that the terms “includes,” “has,” “contains,” and other similar words are used in either the detailed description or the appended claims, such terms are intended to be inclusive—in a manner similar to the term “comprising” as an open transition word—without precluding any additional or other elements. Moreover, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What is claimed is:

1. A system, comprising:
a memory storing computer-executable components; and
a processor, communicatively coupled to the memory, which executes, or facilitates execution of, one or more of the computer-executable components, the computer-executable components, comprising:
a data retrieval component configured to collect diagnostic data from a computing device and save the diagnostic data to a data store;
a filtering component configured to prepare a subset of the diagnostic data based on at least one attribute of a request for the diagnostic data; and
a transfer component configured to transfer the subset of the diagnostic data based on the diagnostic request.

2. The system of claim 1, wherein the data retrieval component is further configured to collect the diagnostic data from the computing device in response to a request for diagnosis from the computing device.

3. The system of claim 1, wherein the data retrieval component is further configured to collect the diagnostic data from the computing device at predefined intervals.

4. The system of claim 2, wherein the request for diagnosis includes identification information associated with the computing device.

5. The system of claim 1, wherein the diagnostic data includes a trace route log from a server to the computing device.

6. The system of claim 1, wherein, in response to the source of the request being associated with technical support, the subset of the diagnostic data comprises: a time of error, an internet protocol address of the computing device, an error code, and an error history log associated with the computing device.

7. The system of claim 1, wherein the transfer component is further configured to transfer the subset of diagnostic data to a media playback analysis component.

8. The system of claim 7, wherein the subset of diagnostic data provided to the media playback analysis component includes information associated with a user session.

9. The system of claim 1, wherein the transfer component is further configured to transfer the subset of diagnostic data to a performance analysis component.

10. The system of claim 9, wherein the subset of diagnostic data provided to the performance analysis component includes information associated with a performance of a user interface on the computing device.

11. A method, comprising:
collecting, by a system including at least one processor, context data from a client device in response to receiving a diagnosis request;
saving, by the system, the context data in a data store;
filtering, by the system, the context data into a subset of context data based on the diagnostic request; and
transferring, by the system, the subset of context data based on the diagnostic request.

12. The method of claim 11, wherein the collecting the context data further comprises collecting the context data from the client device at predefined intervals.

13. The method of claim 11, further comprising identifying, by the system, the client device based on identification data associated with the diagnostic request.

14. The method of claim 11, wherein the collecting the context data further comprises performing a trace route to the client device from a server that performs the collecting the context data.

15. The method of claim 11, further comprising, in response to the diagnostic request being associated with a help desk operator, preparing, by the system, the subset of context data including preparing information that includes a time of error, an internet protocol address of the client device, an error code, and an error history log associated with the client device.

16. The method of claim 11, further comprising transferring, by the system, the subset of context data including transferring information associated with a user session to a media playback analysis system.

17. The method of claim 11, further comprising transferring, by the system, the subset of context data including transferring information associated with a performance of a user interface to a performance analysis system.

18. A non-transitory computer-readable storage device comprising computer-executable instructions that, in response to execution, cause a system including at least one processor to perform operations, comprising:
performing a diagnostic test on a client device in response to receiving a diagnosis request from the client device, wherein the performing the diagnostic test includes tracing a route between a server and the client device;
collecting a first set of data including diagnostic data in response to performing the diagnostic test; and
selecting a second set of data to collect from the client device based on a client device error identified in the diagnosis request.

19. The non-transitory computer-readable storage device of claim 18, wherein the operations further comprise identifying the client device to perform the diagnostic test on based on identification information in the diagnostic request.

20. The non-transitory computer-readable storage device of claim 18, wherein the selecting the second set of data further includes selecting at least one error log associated with the identified client device error.
